(19) United States
(12) Patent Application Publication
(10) Pub. No.: US 2011/0250556 A1
(43) Pub. Date: Oct. 13, 2011

(54) Mounting Arrangement with Mounting Aid and Orthodontic Bracket

(76) Inventor: Wolfgang Heiser, Innsbruck (AT)

(21) Appl. No.: 13/074,424

(22) Filed: Mar. 29, 2011

(30) Foreign Application Priority Data
Apr. 8, 2010 (EP) 10159393.7

(51) Int. Cl. A61C 7/02; A61C 7/12

(52) U.S. Cl. 433/3; 433/8

(57) ABSTRACT

The invention concerns a mounting arrangement for mounting an orthodontic bracket on a tooth. The mounting arrangement comprises an orthodontic bracket and a mounting aid, wherein the mounting aid can be detachably connected to the orthodontic bracket with positive engagement by pushing it onto the bracket in such a way that long sides of the side pieces of the mounting aid engage in guide grooves of the bracket.

### CROSS REFERENCE TO RELATED APPLICATION

This application claims priority based on European patent application EP 10 159 393.7, filed Apr. 8, 2010.

### FIELD OF THE INVENTION

The present invention pertains to a mounting arrangement for the correction of malpositioned teeth with the help of orthodontic brackets, especially to a mounting aid or jig and an associated orthodontic bracket.

### BACKGROUND OF THE INVENTION

One way of correcting malpositioned teeth is to use brackets, which are cemented in predefined positions to the teeth of the upper and lower jaws of the patient and then connected to each other by means of an elastic arch wire. The brackets on the individual teeth are installed in positions which are selected so that, at the end of the orthodontic treatment, the arch wire passing through the brackets is essentially free of waves or undulations. At the beginning of the treatment, the arch wire therefore comprises a highly complex course. Depending on the degree to which the teeth are malpositioned, the relatively long arch wire, which follows the arch of the jaw, undulates to a greater or lesser extent in and outside the plane which it describes.

There are two basic approaches to determining the correct positions in which the brackets are to be cemented to the teeth. According to the first approach, the so-called “direct method,” suitable optical measuring tools are used to measure the patient's teeth directly, i.e., without an impression. There is also a “hand” method, by which the measurement values are obtained by hand and evaluated, as well as the alternative of a computer-aided method.

In the case of the computer-aided method, the recorded measurement values are processed by a computer program. Such a computer program determines the positions of the brackets and also controls a wire bending machine to bend each one of a complete set of arch wires of different cross sections into a relatively complicated shape which takes into account the individual malpositioning of the teeth. Each one of the set of arch wires is used in succession during course of the patient's treatment. This technique is used when the brackets to be used are of the lingual type, that is, brackets which are on the side facing the tongue, because the shapes of the teeth on the lingual side differ considerably from one individual to another. The outline of the crown of the tooth cannot be used for orientation in this case, whereas the shapes of the crowns on the labial side, that is, on the outer side facing the lips, are largely uniform despite the differences between individuals.

In the case of the “hand” method, the measurements in the mouth of the patient are usually very imprecise, which can lead to significant errors in the determination of the bracket positions. Conversely, the computer technique is expensive and very complicated. In view of the relatively small number of orthodontic treatments which make use of lingual brackets, it is uneconomical for an individual orthodontist to acquire such equipment.

The second, more usual, approach to the determination of the positions of the brackets on the teeth is the so-called “Hiro” technique. First, the orthodontist takes an impression of the natural dentition to be corrected. From this impression, a plaster cast of the natural dentition to be corrected is made in the dental laboratory. The individual teeth are sawn from this cast and reassembled with wax in such a way that the perfect occlusion to be achieved by the orthodontic treatment is obtained. Then the arch wire is prepared; brackets are mounted on the arch wire; and the arch wire is brought into position together with the brackets on the lingual side of the corrected cast in such a way that the brackets line up with their assigned teeth in the intended manner, wherein a certain gap is maintained between the brackets and the teeth, which later will be filled up with a casting compound. Next, individual caps of a photocuring acrylic resin are formed over the incisal edge of each tooth; these caps extend down to the brackets and adhere to them. After the caps have cured, the brackets are removed from the arch wire. Then the caps with the brackets suspended from them are placed individually back onto the teeth of the corrected cast, and the intermediate spaces between the base plates of the brackets and the crowns of teeth are filled up with a curable casting compound, as a result of which a so-called individual base for each bracket is prepared. A parting agent is applied to the teeth of the corrected cast to prevent the casting compound from adhering to them.

Upon completion of this preparatory lab work, the orthodontist uses a thin layer of adhesive to cement the set of brackets firmly to the associated teeth of the dentition to be corrected, wherein the caps again serve as gauges, which position the brackets on the teeth in exactly the same way as they were positioned on the corrected plaster cast. After the adhesive has cured, the caps are broken away. This is a time-consuming task, because the acrylic material must be removed completely from the brackets.

The disadvantage of both approaches is that, if a bracket works itself loose from a tooth at any time during the course of the corrective orthodontic treatment, it is difficult to reattach the bracket properly to the tooth again. This job can be performed only with the help of the laboratory. In the case of measurement by hand or by computer, a completely new measurement must be made, and a new set of wires must be prepared, because in most cases the patient does not see his orthodontist immediately and in the intervening period of time the corrected teeth can start to return to their original positions. The unintentional detachment of a bracket is not an uncommon occurrence. Every patient normally experiences such a problem at least once during the course of treatment. In the case of the Hiro technique, a new individual base, including the acrylic cap, must be fabricated for a new bracket in the laboratory using the arch wire as a guide.

In EP 1 374 795 A1, a mounting aid for eliminating the disadvantages discussed above is proposed. The mounting aid disclosed consists of a sheet metal strip, which comprises means for attaching it positively to the bracket; a retaining device for anchoring an elastic tensioning device to the sheet metal strip to hold the strip in place on the bracket; and a lug extending away from the retaining device.

When the known mounting aid according to EP 1 374 795 A1 is used, the first part of the procedure is the same as that of the Hiro technique. Either before or after the brackets are attached to the arch wire, however, the mounting aid is attached to each bracket. The aid is designed so that it rests on the bracket and is detachably fastened to it by means of a tensioning device. Its first end extends toward and preferably beyond the occlusal plane of the teeth. Then the previously mentioned caps of photocuring acrylic resin are formed on the teeth in the usual manner, except that, in contrast to the known technique, only the first end of the mounting aid, not the bracket attached to the mounting aid, is embedded in the resin. Then the acrylic resin is cured.

Further processing then involves the preparation of the individual base of each bracket in the usual manner. The set of brackets thus completed is then made available to the orthodontist together with the mounting aids, which are attached to the brackets and embedded in the caps. The orthodontist then brings the brackets into position on the malpositioned teeth. The caps with the attached mounting aids form assembly gauges or jigs for the attachment of the brackets in their predetermined positions on the teeth. The orthodontist now uses a thin film of adhesive to cement the brackets to the teeth. After the adhesive has cured, the orthodontist removes the assembly jigs from the brackets. There is no need to break away anything. The orthodontist will usually save the assembly jigs, which are individually labeled, so the jigs can be used again if necessary in the event that a bracket comes loose from a tooth at a later time.

The use of the mounting aids or jigs described in EP 1 374 795 A1 suffers from certain disadvantages, however. First, the fixation of the mounting aids to the brackets by means of the tensioning elements is not very precise, because shifts and/or twists can occur. Second, handling is relatively complicated because of the very small dimensions and the large number of projections, hooks, etc., which must be dealt with when using the tensioning elements to attach the mounting aids. Both the attachment of the mounting aids and their detachment from the brackets is quite cumbersome because of the large number of different elements or devices involved and the special tools required.

It is therefore the goal of the present invention to provide a combination of a mounting aid or jig and a bracket which is easy to handle, simple in design, and easy to produce It is also desired to, at the same time, produce an exact and strong connection between the two elements. Furthermore, it is desired to provide a combination of a mounting aid or jig and a bracket which uses a minimal amount of material and which can be adapted for use with a large number of different brackets currently on the market.

### SUMMARY OF THE INVENTION

The desired goals are achieved by the present invention including the aid for mounting orthodontic brackets which is formed out of a strip of material and includes a first and a second end, the second end including means for positive engagement of the aid to the bracket. The means for positive engagement includes two side pieces, which extend in a fork-like manner from the second end, the side pieces further include long sides which are parallel to each other and define a slot there between.

In addition, an orthodontic bracket with a base plate is also contemplated. The orthodontic bracket includes a bottom surface for attachment to tooth, a top surface, and an upper structure extending along the top surface with at least two wings. A slot extends between the two wings to receive an arch wire. The upper structure includes a guide groove on each side allowing a mounting aid to be pushed onto the structure, the grooves being essentially parallel to each other.

According to the invention, a mounting arrangement for the mounting of an orthodontic bracket on a tooth is provided which allows the mounting aid to be positively but detachably connected to the orthodontic bracket by pushing it onto the bracket. The mounting aid having a side piece which includes long sides which frictionally engage in the guide grooves of the bracket when the aid is pushed on. Thus the two inventive objects are connected by a common inventive principle and as a result have a relationship to each other similar to that of a plug-and-socket connection. The mounting aid can act either externally on the upper bracket structure or internally on the upper bracket structure, as long as the corresponding lateral surfaces of the upper bracket structure are suitable for accepting the long sides of the side pieces of the aid. These can be either the inner long sides or the outer long sides of the side pieces, depending on the design of the aid.

With the inventive mounting arrangement, it becomes very easy to handle lingual and buccal brackets when they are first fitted and possibly when they are subsequently installed. In particular, there is no need for additional elements such as tensioning rings or the like or for any additional tools. As a result of the positive and yet detachable connection, it is possible to position the brackets with very high precision. The simple design of the mounting aid saves material in comparison with previous solutions and offers high flexibility, since mounting aids of different sizes can be inexpensively produced for different bracket widths, which are usually between about 2 mm and 5 mm.

It has been found that optimal results with respect to handling and fixation can be obtained with an installation width (defined as the distance between the parallel long sides of the side pieces) of about 0.05-0.1 mm less than the width of the bracket, possibly under consideration of the depth of the guide grooves. Alternative distances are also possible as long as they ensure sufficient elasticity and adequate friction, so that a precise, easily achievable but detachable connection can be obtained.

The mounting aid is preferably axially symmetric in design, and the slot extends essentially along and in the axis of symmetry, which runs from the first end to the second end of the mounting aid.

Especially advantageous is a mounting aid of sheet metal with a thickness of about 0.15-0.8 mm. It is also preferable for the slot to have a length of approximately 1.0-5.0 mm and a width of about 0.1-0.8 mm. Such construction is efficient and cost effective to manufacture.

It is advantageous for at least one side piece to comprise at least one opening. For example, the side pieces can comprise a round opening at each end, into which a spreader tool can engage to assist the process of attachment or detachment. Alternatively, the form of the opening can be of some other effective shape such as a square, elliptical, polygonal, or the like.

The first end can also comprise preferably at least one opening, so that it is possible to grasp the aid with a suitable tool such as a pliers and to bend the first end. This usually makes it possible to achieve better fixation of the caps. Widening the first end can also be advantageous.

Yet another advantage is obtained by providing the slot with a widened section at its closed end. The form of the widened section can be, for example, round, elliptical, polygonal or the like. By terminating the slot in this way, the elastic effect of the slot is given additional stability. The amount of material used can also be reduced at the same time.

According to the invention, an effective connection between the mounting aid and the bracket can also be obtained even if the bracket does not comprise any lateral guide grooves, but instead only two parallel lateral surfaces, which the long sides of the side pieces of the mounting aid can grip.

It is also possible for the guide grooves not to be straight but rather slightly curved but still parallel to each other. The guide grooves on the bracket should be parallel to each other, but their relative arrangement with respect to the bottom surface of the bracket is flexible. As a result, a flexibility is obtained which is necessary in cases of especially pronounced dental malpositions or other geometric requirements.

### BRIEF DESCRIPTION OF THE DRAWINGS

In order that the advantages of the invention will be readily understood, a more detailed description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 shows a top view of an inventive mounting aid according to a first embodiment of the invention;

FIG. 2 shows a side view of the mounting aid according to FIG. 1;

FIG. 3 shows a top view of an inventive mounting aid according to a second embodiment of the invention;

FIG. 4 shows a top view of an inventive mounting aid according to a third embodiment of the invention;

FIG. 5 shows a top view of a bracket of the prior art, which is suitable for cooperating with an inventive mounting aid;

FIG. 6 shows a top view of an inventive bracket according to a preferred embodiment of the invention;

FIG. 7 shows a side view of the bracket according to FIG. 6;

FIG. 8 shows a top view of a mounting arrangement consisting of an inventive mounting aid according to FIG. 1 and the bracket according to FIG. 5;

FIG. 9 shows a top view of an inventive mounting arrangement with a mounting aid according to FIG. 1 and a bracket according to FIG. 6;

FIG. 10 shows a side view of an inventive mounting aid according to a third embodiment of the invention;

FIG. 12 shows a side view of the mounting aid according to FIG. 11;

FIG. 13 shows a top view of an inventive bracket according to another embodiment of the invention;

FIG. 14 shows a side view of the bracket according to FIG. 13;

FIG. 15 shows a top view of an inventive mounting arrangement with a mounting aid according to FIG. 11 and a bracket according to FIG. 13;

FIG. 16 shows a side view of the inventive mounting arrangement according to FIG. 15;

FIG. 17 shows a perspective view of an inventive bracket according to another embodiment of the invention;

FIG. 18 shows a perspective view of an inventive mounting arrangement with the bracket according to FIG. 11 and a mounting aid according to FIG. 1 in a first, incompletely pushed-on position; and

FIG. 19 shows a perspective view of the inventive mounting arrangement according to FIG. 12 with the mounting aid pushed completely onto the bracket.

### DETAILED DESCRIPTION OF THE INVENTION

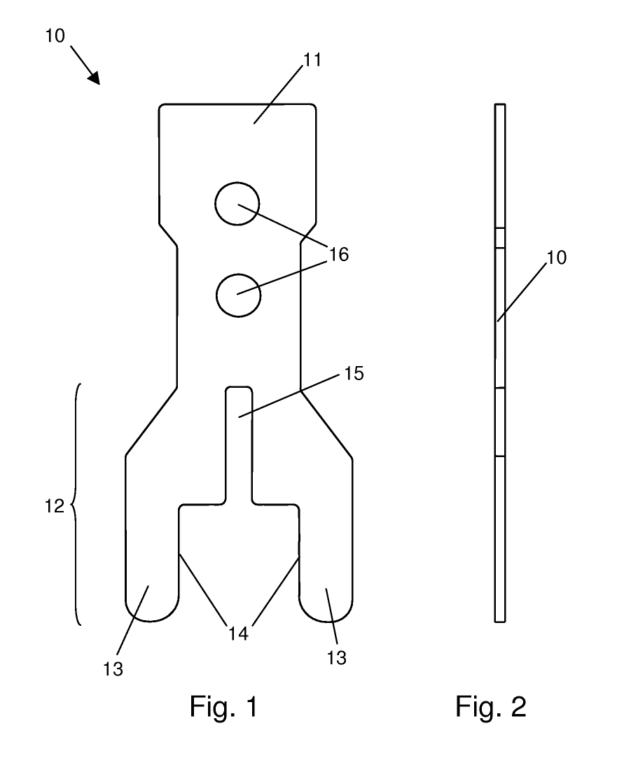

FIG. 1 shows a top view of a first embodiment of an inventive aid 10 on a greatly enlarged scale. It should be noted in this relation that the components used for the inventive mounting arrangement, that is, the inventive mounting aid and the inventive bracket, are relatively small components, and accordingly all of the components are shown on an enlarged scale in all of the figures. The overall length of the mounting aid 10, for example, is approximately 10 mm; its greatest width is approximately 5 mm. The other details of the component are of corresponding size.

Mounting aid 10 is produced from a sheet metal strip with a thickness of about 0.2 mm. It comprises a first end 11, a central part, and a second end 12. In the embodiment shown in FIG. 1, mounting aid 10 is axially symmetric with respect to a center axis, which runs from first end 11 to second end 12. Second end 12 comprises two parallel side pieces 13 of essentially the same length, each of which comprises long inner sides 14, which are parallel to each other. At the base of the fork-like opening between two side pieces 13, there is a slot 15, which, in the present exemplary embodiment, has a width of about 0.5 mm and a length of about 2.3 mm. First end 11 is somewhat wider than the central part and comprises two round openings 16 in the middle, in which a tool, for example, can engage. Second end 12 of mounting aid 10 is wider than its first end 11.

FIG. 2 shows a side view of mounting aid 10 of FIG. 1. It is possible to see the relatively thin sheet metal strip, which can be produced relatively easily from sheet material by stamping, cutting, milling, sawing or any similar machining process.

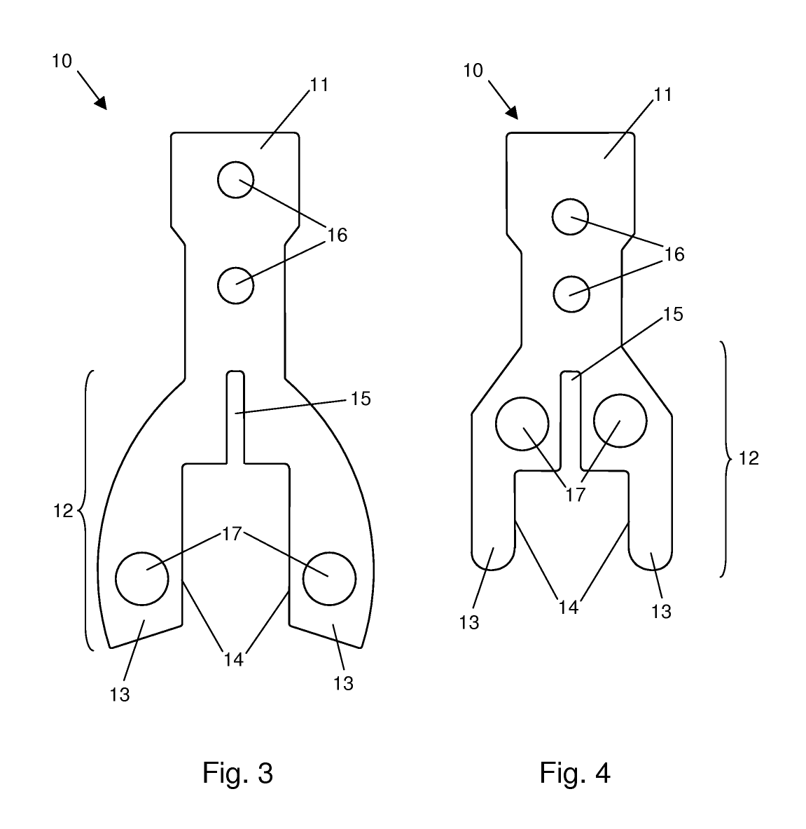

FIG. 3 shows a top view of an inventive mounting aid according to a second embodiment. The configuration of first end 11 is essentially identical to the configuration of mounting aid of FIG. 1, only the shape of side pieces 13 is different. It can be seen that side pieces 13 comprise a curved shape along their outer sides and that there is a round opening 17 at each end. A spreading pliers or a similar tool can engage in these openings 17 to move the side pieces apart and thus to support the process of pushing the aid onto, or of removing it from, a bracket. The shape of opening 17 does not have to be round; other suitable shapes such as elliptical, rectangular, polygonal, or the like can also be used.

FIG. 4 shows a top view of an inventive mounting aid according to another embodiment, wherein second end 12 comprises an opening 17 on each of the two sides of the slot 15, into which a spreading pliers as described above can positioned and engaged. In contrast to the exemplary embodiment shown in FIG. 3, openings 17 are not at the ends of side pieces 13 but rather positioned close to the central part of the mounting aid. Because the leverage is different here, more force must be applied to the spreading pliers to bend two side pieces 13 apart.

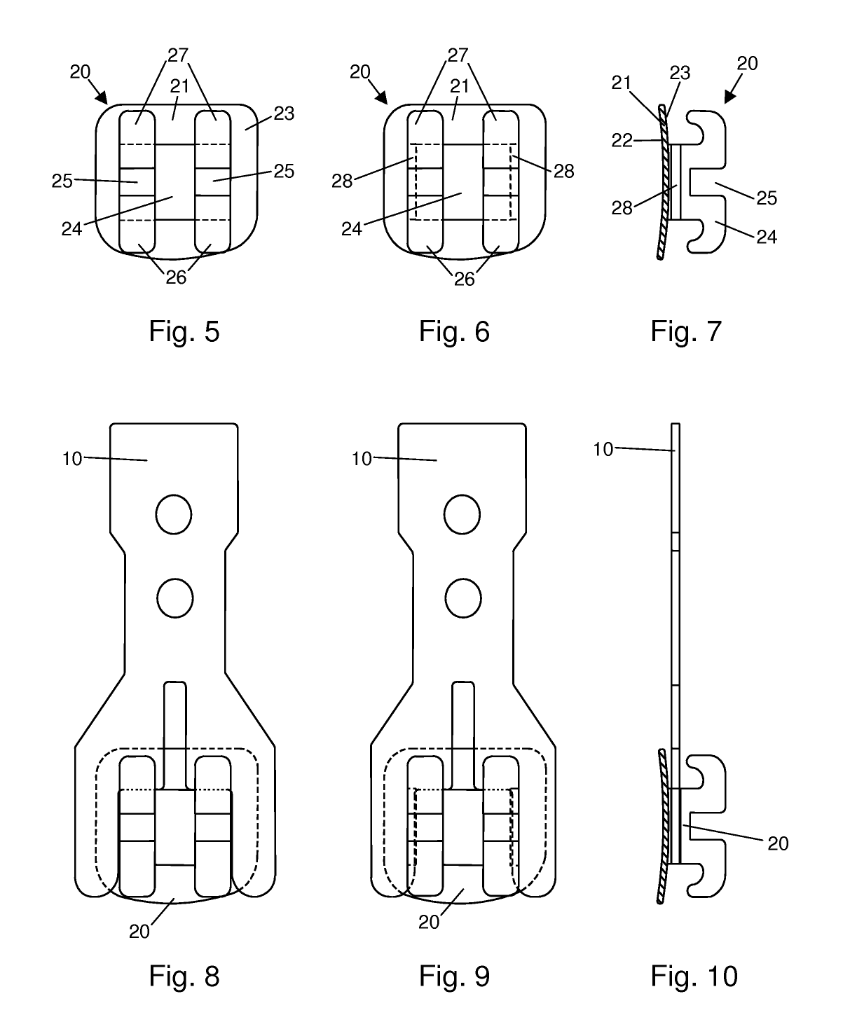

FIG. 5 shows a top view of a per se known bracket 20, which can be combined with inventive mounting aid 10 under certain conditions to form an inventive mounting arrangement for brackets. Bracket 20 comprises a base plate 21, the bottom surface 22 which may be cemented to the tooth. An upper structure 24, which comprises a slot 25 to receive an arch wire, extends from the top surface 23 of base plate 21. In the embodiment shown in FIG. 5, the upper structure comprises two first wing halves 26 and two second wing halves 27, between which are located both the previously mentioned slot 25 for the arch wire and an empty space perpendicular to the slot. The key point which makes it possible for the mounting aid and the bracket to cooperate in the inventive manner is the design of the outer or lateral side pieces of upper structure 24 perpendicular to the course of slot 25. If the two lateral side pieces of upper structure 24 are parallel to each other and comprise an essentially flat surface, the bracket is suitable for being held in place by mounting aid 10, as will be described below by reference to FIG. 8.

FIG. 6 shows a top view of an inventive bracket, which in principle comprises same upper structure 20 with the same elements as the bracket according to FIG. 5. The difference between these two embodiments consists in that each of the lateral side pieces of upper structure 24 has a guide groove 28; these two grooves are parallel to each other and are essentially straight, so that mounting aid 10 can engage precisely in the guide grooves in the manner of an open-end wrench and thus be pushed onto bracket 20, as will be described below with reference FIGS. 9 and 10.

FIG. 7 shows a side view of the embodiment of the bracket of FIG. 6, with slot 25 and guide grooves 28. The width and the depth of guide grooves 28 must be structured in such a way that mounting aid 10 can be pushed on easily and retained adequately on bracket 20 but also so that mounting aid 10 can be easily removed.

FIGS. 8 and 9 show top views of an embodiment of the invention with the bracket according to FIGS. 5 and 6, respectively, and with mounting aid 10 in the embodiment according to FIG. 1. As can be seen in FIG. 8, long inner sides 14 of side pieces 13 of mounting aid 10 positively engage upper structure 24 of bracket 20. The elasticity of the sheet metal allows slot 15 of mounting aid 10 to expanded slightly toward the opening, so that an adequate clamping and holding action is obtained. As can be seen, the bracket in the embodiment according to FIG. 8 does not comprise any lateral guide grooves. Hence, the connection is not as precise as in the embodiments with guide grooves (see FIG. 9 below). In such a configuration without guide grooves, long inner sides 14 of side pieces 13 could wedge themselves in such a way that the orientation of mounting aid 10 in the plane in which it is pushed into place is no longer exactly perpendicular to the course of the lateral side pieces of upper structure 24 of bracket 20.

FIGS. 9 and 10 show top and side views of the inventive mounting arrangement consisting of mounting aid 10 and the bracket according to FIGS. 6 and 7. The fixation or connection between the mounting aid and the bracket is more secure in such an embodiment, in contrast to the embodiment according to FIG. 8, as guide grooves 28 ensure the precise guidance and thus positioning of long inner sides 14 of side pieces 13 of mounting aid 10 on the lateral side pieces of upper structure 24 of bracket 20. It can be seen that in the direction of mounting the aid onto the bracket there is a frictional engagement whereas in at least one direction perpendicular thereto there is a positive engagement between side pieces 13 and the lateral side pieces or grooves 28 of upper structure 24 of bracket 20.

FIG. 11 shows a top view of another preferred embodiment of the inventive aid. Because the majority of the elements are essentially identical to the elements described in reference to the embodiment illustrated in FIG. 1, only the differences will be discussed here. One such difference consists in that side pieces 13 arranged at second end 12 of mounting aid 10 represent an extension of slot 15. Two side pieces 13 are not designed in this embodiment in the form of an open-end wrench but rather more in the manner of a thin fork. This can be advantageous in terms of handling, because overall dimensions are smaller than those in the embodiments described above. In the case of aid 10 according to FIG. 11, slot 15 comprises at its closed end a widened section 18 in the form of a circle, into which a tool can also engage. For the inventive function, side pieces 13 in this embodiment comprise outward-facing long sides 14, which are parallel to each other. The long inner sides form the boundaries of slot 15.

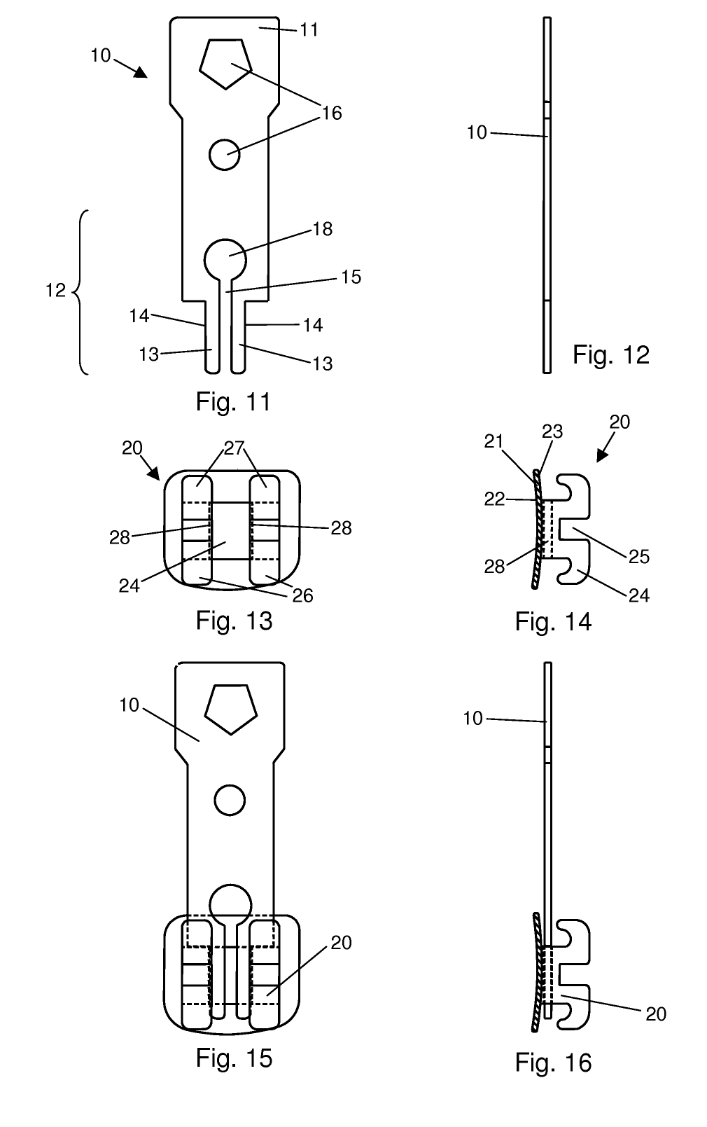

FIG. 12 shows a side view of mounting aid 10. The sheet metal material is approximately 0.25 thick.

FIG. 13 shows a top view of inventive bracket 20, which, together with the mounting aid of FIG. 11, forms the mounting arrangement shown in FIG. 15 according to another embodiment of the invention. The essential components of bracket 20 are identical to those described in relation to FIG. 6, wherein the difference is that guide grooves 28 are not on the outer surfaces of upper structure 24 but rather on its inner surfaces, perpendicular to slot 25. It is obvious that, in the case of upper structure 24 shown in this embodiment, the intermediate space between first and second wing halves 26 and 27 must be deep enough to accommodate guide grooves 28. FIG. 14 shows a cross-sectional view of the bracket of FIG. 13.

FIGS. 15 and 16 show top and cross-sectional views of the two components, namely, aid 10 and bracket 20, assembled to form one embodiment of an inventive mounting arrangement. It is easy to see how aid 10 is located internally in upper structure 24 of the bracket and how long sides 14 of side pieces 13 engage in guide grooves 28, thus producing the necessary retention effect. Here, too, it is true that bracket 20 does not necessarily have to comprise guide grooves 28 on the upper structure but rather only parallel inner surfaces on upper structure 24.

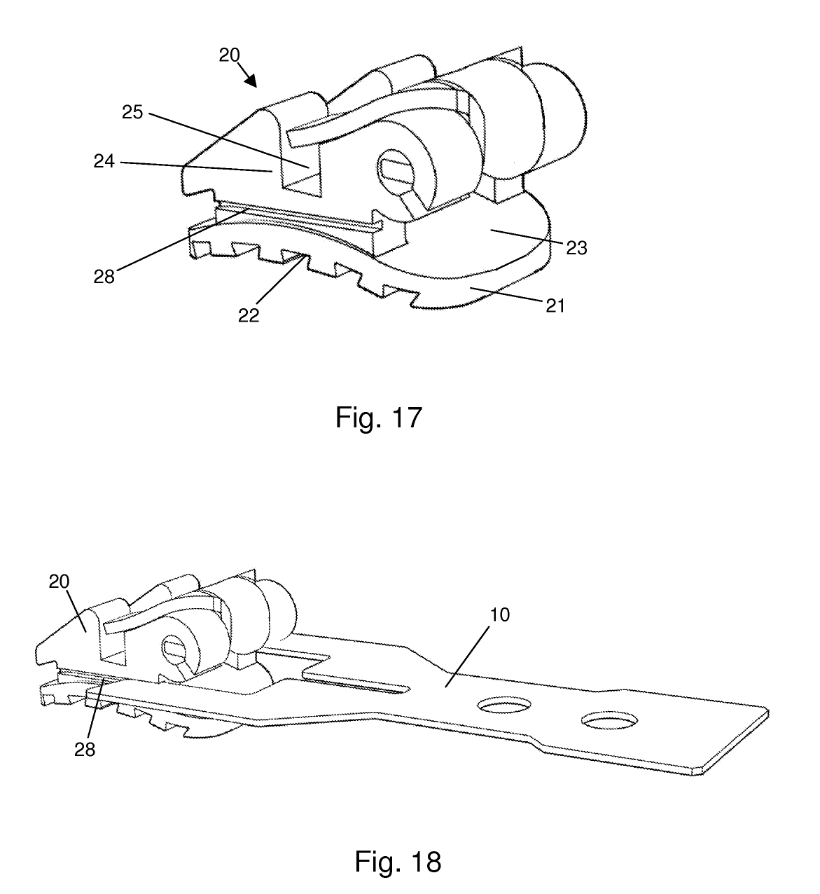

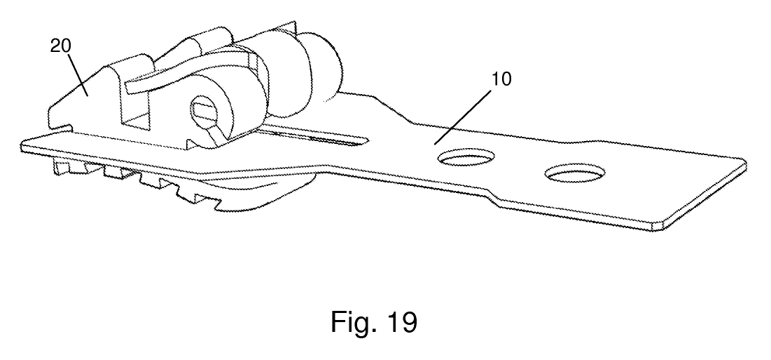

FIGS. 18 and 19 show perspective views of an inventive mounting arrangement with the mounting aid in different positions on bracket 20. FIG. 17 shows another embodiment of an inventive bracket, wherein the upper bracket structure known in itself is not crucial to the functionality of the present invention. What is shown in FIGS. 17-19 is an upper bracket structure with a spring element, by means of which the arch wire is held in slot 25. As previously mentioned, the lateral side pieces of upper structure 24 comprise essentially parallel surfaces and, most preferably, all exactly parallel guide grooves 28 in order to guide long sides 14 of side pieces 13 of the mounting aid with precision.

With the present invention, a combination of a mounting aid and a bracket is provided, the handling, design, and production of which are very simple, which simultaneously produces a precise and strong connection between the two elements, which requires only a modest amount of material, and which can be used flexibly for a large number of commercially available orthodontic brackets.

Reference throughout this specification to “one embodiment,” “an embodiment,” “a preferred embodiment,” “alternate embodiment” or similar language means that a particular feature, structure, or characteristic described in connection with the embodiment is included in at least one embodiment of the present invention. Thus, appearances of the phrases “in one embodiment,” “in an embodiment,” “in a preferred embodiment,” “in an alternate embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

While the present invention has been described in connection with certain exemplary, alternate or specific embodiments, it is to be understood that the invention is not limited to the disclosed embodiments, but, on the contrary, is intended to cover various modifications, alternatives, modifications and equivalent arrangements as will be apparent to those skilled in the art. Any such changes, modifications, alternatives, modifications, equivalents and the like may be made without departing from the spirit and scope of the invention.

What is claimed is:

1. An aid for mounting orthodontic brackets, formed from a strip of material with a first end and a second end, the second end comprising means for positive engagement with the bracket, wherein the means for positive engagement comprise two side pieces, extending in a fork-like manner from the second end, the long sides of the side pieces being essentially parallel to each other, wherein the aid comprises a slot between the two side pieces.

2. The aid according to claim 1 wherein the aid is axially symmetric in design, and wherein the slot extends essentially along and in the axis of symmetry.

3. The aid according to claim 1 wherein the aid is formed out of sheet metal with a thickness of about 0.15-0.8 mm.

4. The aid according to claim 2 wherein the aid is formed out of sheet metal with a thickness of about 0.15-0.8 mm.

5. The aid according to claim 1 wherein the slot comprises a length of about 1.0-5.0 mm and a width of about 0.1-0.8 mm.

6. The aid according to claim I wherein at least one side piece comprises at least one opening.

7. The aid according to claim 1 wherein the slot comprises a widened section at its closed end.

8. The aid according to claim 1 wherein the first end comprises at least one opening.

9. The aid according to claim 1 wherein the first end comprises a widened area.

10. An orthodontic bracket with a base plate, which comprises a bottom surface for attachment to a tooth and a top surface, and with an upper structure extending from the top surface with at least two wings, between which a slot to receive an arch wire is located, wherein the upper structure comprises two lateral guide grooves, which allow a mounting aid to be pushed onto the structure, and which are essentially parallel to each other.

11. The bracket according to claim 10 wherein the guide grooves are formed externally on the upper structure.

12. The bracket according to claim 10 wherein the guide grooves are formed internally on the upper structure in such a way that they are opposite each other.

13. The bracket according to claim 10 wherein the guide grooves are straight or are bent in correspondence with the curvature of the bottom surface of the base plate.

14. A mounting arrangement for the mounting of an orthodontic bracket on a tooth comprising
an aid for mounting orthodontic brackets, formed from a strip of material with a first end and a second end, the second end comprising means for positive engagement with the orthodontic bracket including two side pieces, extending in a from the second end defining a slot there between, the long sides of the side pieces being essentially parallel to each other; and
the orthodontic bracket having a base plate, which comprises a bottom surface for attachment to a tooth and a top surface, and with an upper structure extending from the top surface with at least two wings, between which a slot to receive an arch wire is located, wherein the upper structure comprises two lateral guide grooves, which allow a mounting aid to be connected positively but detachably to the orthodontic bracket by pushing the aid onto the bracket such that the long sides of the side pieces of the aid engage in the guide grooves of the bracket.
